(19) United States
(12) Patent Application Publication
(10) Pub. No.: US 2017/0055144 A1
(43) Pub. Date: Feb. 23, 2017

(54) ALTERNATIVE ROAMING PROVIDER

(71) Applicant: Alcatel Lucent, Boulogne Billancourt (FR)

(72) Inventor: Xiangyang LI, Shanghai (CN)

(73) Assignee: ALCATEL LUCENT, Boulogne Billancourt (FR)

(21) Appl. No.: 15/307,496

(22) PCT Filed: Apr. 15, 2015
(86) PCT No.: PCT/IB2015/000785

§ 371 Date: Oct. 28, 2016

(30) Foreign Application Priority Data
Apr. 28, 2014 (CN) 201410175476.9

(51) Int. Cl. H04W 8/12

(52) U.S. Cl. CPC H04W 8/12; H04M 15/51

(57) ABSTRACT

According to one aspect of the present invention, there is provided a method for serving a roaming mobile terminal in an HLR of a mobile communication system, wherein the method comprises steps of: a. determining location information of the mobile terminal based on a location update request of the mobile terminal as provided by an MSC of a country or region where the mobile terminal is located; b. when determining, based on location information of the mobile terminal, that the mobile terminal is in roaming and located in a predetermined roaming country or predetermined roaming region, generating a first Original-CSI of the mobile terminal, wherein a predetermined address entry in the first Original-CSI includes address information of an ARP proxy engine; c. transmitting the first Original-CSI to the MSC. According to the solution of the present invention, the user may simultaneously enjoy roaming services provided by its home service provider and the non-home service provider without changing the SIM card during roaming; besides, the user may select a service provider providing a roaming service at a lower price from among a plurality of service providers, thereby reducing the user's roaming charge.

### FIELD OF THE INVENTION

The present invention relates to the field of mobile communications, and more specifically to a method, apparatus, and system for serving a roaming mobile terminal in a mobile communication system.

### BACKGROUND OF THE INVENTION

In the prior art, when a subscriber roams beyond an SIM card issuing area, he/she has to use roaming services provided by an service provider issuing the SIM card, which would generate expensive roaming charges. Currently, most subscribers would opt to use an SIM card issued in the roaming area instead when they are in roaming, particularly, in international roaming, so as to avoid generation of expensive roaming charges. However, change of the SIM card causes a subscriber to use a different number when he/she is in roaming, which brings many inconveniences to the subscriber.

### SUMMARY OF THE INVENTION

An objective of the present invention is to provide a method, apparatus, and system for serving a roaming terminal in a mobile communication system.

According to one aspect of the present invention, there is provided a method for serving a roaming mobile terminal in an HLR of a mobile communication system, wherein the method comprises steps of:

a. determining location information of the mobile terminal based on a location update request of the mobile terminal as provided by an MSC of a country or region where the mobile terminal is located;

b. when determining, based on location information of the mobile terminal, that the mobile terminal is in roaming and located in a predetermined roaming country or predetermined roaming region, generating first Original-CSI of the mobile terminal, wherein a predetermined address entry in the first Original-CSI includes address information of an ARP proxy engine;

c. transmitting the first Original-CSI to the MSC.

According to another aspect of the present invention, there is further provided a method for serving a roaming mobile terminal in an ARP proxy engine in a mobile communication system, wherein the method comprises steps of:

A. receiving call information of the mobile terminal from a Gateway or MSC of a country where the mobile terminal is located;

B. selecting a charging system provided by either a home service provider or a non-homer service provider of the mobile terminal based on the call information;

C. routing the call information to the selected charging system.

According to another aspect of the present invention, there is further provided a first serving apparatus for serving a roaming mobile terminal in an HLR of a mobile communication system, wherein the first serving apparatus comprises:

a determining module configured to determine location information of the mobile terminal based on a location update request of the mobile terminal as provided by an MSC of a country or region where the mobile terminal is located;

a first generating module configured to, when determining, based on location information of the mobile terminal, that the mobile terminal is in roaming and located in a predetermined roaming country or predetermined roaming region, generate first Original-CSI of the mobile terminal, wherein a predetermined address entry in the first Original-CSI includes address information of an ARP proxy engine;

a first transmitting module configured to transmit the first Original-CSI to the MSC.

According to a further aspect of the present invention, there is also provided a second serving apparatus for serving a roaming mobile terminal in an ARP proxy engine in a mobile communication system, wherein the second serving apparatus comprises:

a second receiving module configured to receive call information of the mobile terminal from a Gateway or MSC of a country where the mobile terminal is located;

a selecting module configured to select a charging system provided by either a home service provider or a non-homer service provider of the mobile terminal based on the call information;

a routing module configured to route the call information to the selected charging system.

According to a further aspect of the present invention, there is further provided a mobile communication system, comprising a first serving apparatus and a second serving apparatus according to the present invention.

Compared with the prior art, the present invention has the following advantages: 1) a subscriber may select a non-home service provider in its home country or region other than its home service provider to provide roaming services for the mobile terminal, so as to both enjoy roaming services provided by its home service provider and the non-home service provider without number change, such that when the mobile terminal is roaming in its predetermined roaming country or predetermined roaming region, selection may be performed between a charging system provided by its home service provider or a charging system provided by the non-home service provider; 2) according to the solution of the present embodiments, the subscriber is provided a greater selectivity, such that the subscriber may select a roaming service provided by a non-home service provider with less roaming charge based on the country or region where he or she is roaming, thereby greatly reducing the expenses for roaming; 3) when the mobile terminal is roaming in its predetermined roaming country or predetermined roaming region and when the mobile terminal is a calling party, a charging system can be selected through an ARP proxy engine without number change, thereby enhancing the flexibility of the roaming service, and lowering the roaming charge in some cases; 4) when the mobile terminal is roaming in its predetermined roaming country or predetermined roaming region and when the mobile terminal is a called party, a charging system provided by the non-home service provider of the terminal may be used to charge the roaming without number change, thereby reducing roaming charges.

### BRIEF DESCRIPTION OF THE ACCOMPANYING DRAWINGS

Other features, objectives and advantages of the present invention will become more apparent through reading the detailed description of the non-limiting embodiments with reference to the accompanying drawings:

FIG. 1 shows a structural diagram of a mobile communication system according to one embodiment of the present invention;

FIG. 2 shows a flow diagram of a method for serving a roaming mobile terminal in a mobile communication system according to one embodiment of the present invention;

FIG. 3 shows a flow diagram of a method for serving a roaming mobile terminal in a mobile communication system according to another embodiment of the present invention;

FIG. 4 shows a flow diagram of a method for serving a roaming mobile terminal in a mobile communication system according to a further embodiment of the present invention;

FIG. 5 shows a structural diagram of a system for serving a roaming mobile terminal in a mobile communication system according to one embodiment of the present invention;

FIG. 6 shows a structural diagram of a system for serving a roaming mobile terminal in a mobile communication system according to another embodiment of the present invention;

FIG. 7 shows a structural diagram of a system for serving a roaming mobile terminal in a mobile communication system according to a further embodiment of the present invention.

In the accompanying drawings, the same or similar reference numerals represent the same or similar components.

### DETAILED DESCRIPTION OF THE PREFERRED EMBODIMENTS

Hereinafter, the present invention will be described in further detail with reference to the accompanying drawings.

First, terms appearing in the present invention will be explained:

CAMEL: Customized Application for Mobile network Enhanced Logic

MSC: Mobile Switching Center

MS: Mobile Station

HLR: Home Location Register

VLR: Visitor Location Register

GMSC: Gateway Mobile Switching Center

MAP: Mobile Application Part

CAP: CAMEL Application Part

CSI: CAMEL Subscribe Information

ISUP: ISDN User Part

MSRN: Mobile Station Roaming Number

IMSI: International Mobile Subscriber Identification Number

SCF: Service Control Function

ARP: Alternative Roaming Provider

DSP: Domestic Service Provider

BBR: Request Report BCSM Event

AC: Apply Charging

CUE: Continue

It should be noted that “Domestic” in DSP refers to the registration country of the mobile terminal; for example, if mobile terminal is registered in France, then the DSP is a French service provider.

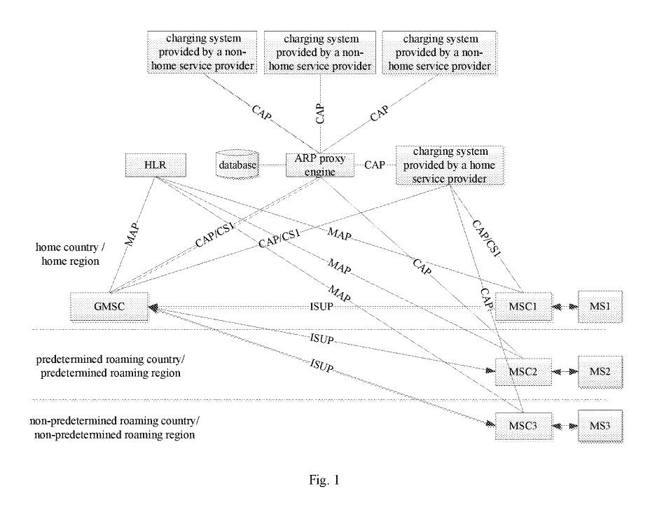

FIG. 1 shows a structural diagram of a mobile communication system according to one embodiment of the present invention. The mobile communication system comprises: GMSC, HLR, MSC, MS, ARP proxy engine, a charging system provided by a non-home service provider, a charging system provided by a home service provider, and a database used by the ARP proxy engine.

Wherein, the GMSC, the HLR, the ARP proxy engine, the charging system provided by the non-home service provider, the charging system provided by the home service provider, and the database used by the ARP proxy engine are all located in a home country or home region of the mobile terminal. Preferably, the ARP proxy engine may be connected to charging system(s) provided by one or more non-home service provider; more preferably, the ARP proxy engine may be provided by a home service provider, wherein the home service provider represents a service provider with which the mobile terminal is registered, and the home country or home region represents the country or region where the mobile terminal is registered. Herein, the non-home service provider may be any service provider other than the home service provider; preferably, the services provided by the non-home service provider and the home service provider may be suitable for the same SIM card, e.g., both of the non-home service provider and the home service provider are service providers within a home country or home region, and adopt the same SIM card standard, etc. Preferably, a subscriber using the mobile terminal may select one from among a plurality of service providers other than the home service provider in the home country or home region as the non-home service provider of the mobile terminal, so as to provide roaming services to the mobile terminal.

Wherein, the MSC comprises MSC1, MSC2, and MSC3; MS comprises MS1, M52, and M53. Herein, the MSC1 and MS1 are located in the home country or home region of the mobile terminal; MSC2 and M52 are located in a predetermined roaming country or predetermined roaming region; and MSC3 and M53 are located in a non-predetermined roaming country or non-predetermined roaming region.

Herein, the predetermined roaming country or predetermined roaming region may be designated by a roaming service provided by a non-home service provider of the mobile terminal; preferably, the predetermined roaming country includes a EU country, and the non-home service provider determines the above predetermined roaming country or predetermined roaming region based on the EU roaming Regulation.

Wherein, the non-predetermined roaming country or non-predetermined roaming region represents other roaming country or roaming region than the predetermined roaming country or predetermined roaming region.

For example, if the home country of the mobile terminal is France, the predetermined roaming countries for the mobile terminal as designated in the roaming services provided by the non-home service provider of the mobile terminal include: Italy, Netherland, Britain; while the non-predetermined roaming countries of the mobile terminal are other roaming countries than the above predetermined roaming countries.

It should be noted that the above diagram is only for better illustrating the technical solution of the present invention, not limiting the present invention. Those skilled in the art should understand that any modification to the system shown in FIG. 1 within the basic idea range of the present invention, e.g., replacing the GMSC with other gateway or the like, should be included within the scope of the present invention.

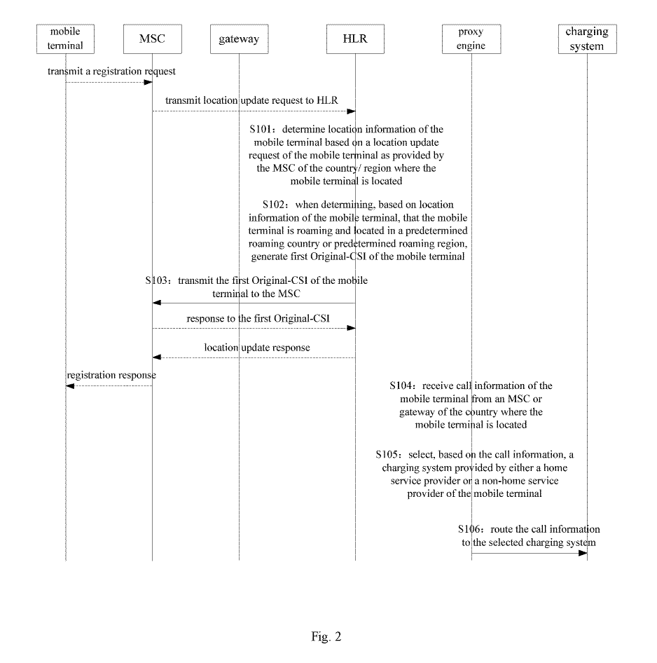

FIG. 2 shows a flow diagram of a method for serving a roaming mobile terminal in a mobile communication system, wherein the charging system of FIG. 2 includes a charging system provided by the home service provider and a charging system provided by a non-home service provider. The method according to the present embodiment comprises step S101, step S102, step S103, step S104, step S105, and step S106.

Hereinafter, a registration process including step S101, step S102, and step S104 and initiated by the mobile terminal to the MSC will be firstly introduced.

Before step S101, when a mobile terminal roams to a country or region, the mobile terminal sends a registration request to an MSC in the country or region where it is located, to request for registration with a VLR corresponding to the MSC.

After receiving the registration request from the mobile terminal, the MSC sends a location update request to the HLR of the mobile terminal.

In step S101, the HLR determines location information of the mobile terminal based on a location update request of the mobile terminal as provided by the MSC of the country or region where the mobile terminal is located.

Herein, the location update request is for requesting for updating a current location of the mobile terminal recorded in the HLR. Preferably, the location update request includes, but not limited to:

1) identification information of the mobile terminal, e.g., IMIS code of the mobile terminal;

2) MSC address information of the country/region where the mobile terminal is located, the address information is for indicating the address of the MSC;

3) the number information of the VLR of the country/region where the mobile terminal is located, the number information being for defining the ISDN number of the VLR.

Specifically, the HLR determines current location information of the mobile terminal based on a location update request for the mobile terminal as provided by the MSC of the country/region where the mobile terminal is located.

For example, the HLR determines the country or region where the MSC is located, based on the location update request for the mobile terminal as provided by the MSC of the country/region where the mobile terminal is located, thereby determining the current location information of the mobile terminal.

It should be noted that the above example is only for better illustrating the technical solution of the present invention, not limiting the present invention. Those skilled in the art should understand that any implementation manner of determining location information location information of the mobile terminal based on a location update request for the mobile terminal as provided by the MSC of the country/region where the mobile terminal is located should be included within the scope of the present invention.

In step S102, when determining, based on location information of the mobile terminal, that the mobile terminal is roaming and located in a predetermined roaming country or predetermined roaming region, the HLR generates first Original-CSI of the mobile terminal.

Wherein, the first Original-CSI indicates subscription information when the mobile terminal located in the predetermined roaming country or predetermined roaming region is a calling party. Preferably, a predetermined address entry in the first Original-CSI includes address information of an ARP proxy engine.

Wherein, the predetermined address entry in the first Original-CSI indicates an address entry of the location to which a call from the mobile terminal as a calling party is routed; preferably, the predetermined address entry is an SCF address.

For example, the HLR determines, based on the location information of the mobile terminal, that the country where the mobile terminal is currently located is not its home country and the country where the mobile terminal is currently located is its predetermined roaming country; then the HLR generates first Original-CSI of the mobile terminal and sets an SFC address in the first Original-CSI as the address of the ARP proxy engine.

It should be noted that the above example is only for better illustrating the technical solution of the present invention, not limiting the present invention. Those skilled in the art should understand any manner of generating first Original-CSI of the mobile terminal when determining that the mobile terminal is roaming and located in a predetermined roaming country or predetermined roaming region based on location information of the mobile terminal should be included within the scope of the present invention.

In step S103, the HLR transmits the first Original-CSI of the mobile terminal to the MSC that transmits a location update request to the HLR.

For example, in the system as shown in FIG. 1, the MSC2 transmits a location update request to the HLR before step S101, and in step S103, the HLR transmits first Original-CSI to the MSC2.

Preferably, the HLR may transmits the first Original-CSI of the mobile terminal to the MSC through an Insert Subscribe Data message transmitted to the MSC, wherein the Insert Subscribe Data message may further include MSIDSN (mobile IDSN number) and Bearer Service information, etc.

Preferably, after step S103, the present embodiment further comprises steps of: after receiving the first Original-CSI from the HLR, the MSC transmits a response to the first Original-CSI to the HLR; after receiving the response, the HLR transmits, to the MSC, a location update response to the location update request from the MSC; after receiving the location update response, the MSC transmits its response to the registration request to the mobile terminal, to complete registration of the mobile terminal in the MSC. These preferred steps are represented in dotted line.

After the registration is completed, the mobile terminal may make a call. Hereinafter, in the case that the HLR generates the first Original-CSI, a process of selecting a charging system for a call from the mobile terminal, including steps S104, S105, and step S106, will be illustrated.

In step S104, the ARP proxy engine receives call information of the mobile terminal from an Gateway or MSC of the country where the mobile terminal is located.

Herein, the call information is for triggering a call service flow, wherein the call information may include any information related to the current call. Preferably, the call information includes: service key, status of the mobile terminal, a calling party number, a called party number, location information of the calling party, and location information of the called party, etc.

In the present embodiment, the gateway is a GMSC of the home country or region of the user.

In step S105, the ARP proxy engine selects, based on the call information, a charging system provided by either a home service provider or a non-home service provider of the mobile terminal.

Wherein, a specific implementation manner in which the ARP proxy engine selects, based on the call information, a charging system provided by either a home service provider or a non-home service provider of the mobile terminal will be described in detail in subsequent embodiments, which will not be detailed here.

In step S106, the ARP proxy engine routes the call information to the selected charging system.

Preferably, after step S106, the method of the present embodiment may also perform a related call charging flow. The call charging flow will be described in detail in the subsequent embodiments, which will not be detailed here.

According to the solution in the present embodiment, a subscriber may select a non-home service provider in its home country or region other than its home service provider to provide roaming services for the mobile terminal, so as to both enjoy roaming services provided by its home service provider and the non-home service provider without number change, such that when the mobile terminal is roaming in its predetermined roaming country or predetermined roaming region, selection may be performed between a charging system provided by its home service provider or a charging system provided by the non-home service provider; according to the solution of the present embodiment, the subscriber is provided a greater selectivity, such that the subscriber may select a roaming service provided by a non-home service provider with less roaming charge based on the country or region where he or she is roaming, thereby greatly reducing the expenses for roaming.

As a preferred solution, the method according to the present embodiment further comprises the following steps (not shown): when determining, based on location information of the mobile terminal, that the mobile terminal is in roaming and located in a non-predetermined roaming country or non-predetermined roaming region, the HLR generates a second Original-CSI of the mobile terminal; and the HLR transmits the second Original-CSI to the MSC providing a location update request.

Wherein the second Original-CSI indicates subscription information of the mobile terminal located in a non-predetermined roaming country or non-predetermined roaming region as a calling party. Herein, a predetermined address entry in the second Original-CSI includes address information of the charging system of the home service provider of the mobile terminal.

For example, the HLR determines, based on the location information of the mobile terminal, that the country where the mobile terminal is located is not its home country, and the country where the mobile terminal is its non-predetermined roaming country, then the HLR generates second Original-CSI of the mobile terminal, and sets the predetermined address entry in the second Original-CSI as an address of the charging system of the home service provider of the mobile terminal; and the HLR transmits the second Original-CSI to the MSC.

Therefore, when the mobile terminal roams to a non-predetermined roaming country or a non-predetermined roaming region, the home service provider of the mobile terminal may charge roaming of the mobile terminal.

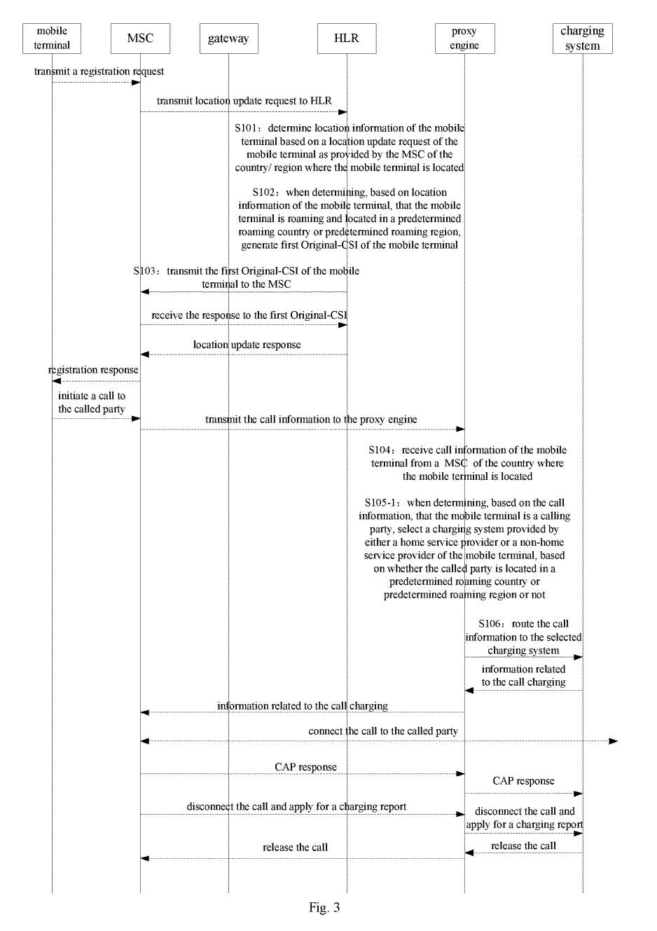

FIG. 3 shows a flow diagram of a method for serving a roaming mobile terminal in a mobile communication system according to another embodiment of the present invention. Herein, the charging system as shown in FIG. 3 includes a charging system provided by a home service provider and a charging system provided by a non-home service provider. The method according to the present embodiment includes step S101, step S102, step S103, step S104, step S105, and step S106, wherein the step S105 further comprises a step S105-1. Herein, the step S101, step S102, step S103, step S104, and step S106 have been described in detail with reference to FIG. 2, which will not be detailed here.

It should be noted that in the present embodiment, the mobile terminal is in roaming and located in a predetermined roaming country or predetermined roaming region, and the mobile terminal is a calling party. The method of the present embodiment further comprises: before step S104, the mobile terminal initiates a call to another mobile terminal through the MSC; and the MSC transmits the call information to the ARP proxy engine based on the first Original-CSI provided by the HLR in step S103. Therefore, in step S104, the ARP proxy engine receives call information of the mobile terminal from the MSC of the country or region where the mobile terminal is located.

In step S105-1, when determining, based on the call information, that the mobile terminal is a calling party, the ARP proxy engine selects a charging system provided by either a home service provider or a non-home service provider of the mobile terminal, based on whether the called party is located in a predetermined roaming country or predetermined roaming region or not.

Specifically, when determining that the mobile terminal is the calling party based on the call information, the ARP proxy engine obtains information of the called party based on the call information. When determining, based on the information of the called party, that the called party is a subscriber of the mobile terminal in the predetermined roaming country or predetermined roaming region, the ARP proxy engine selects a charging system provided by the non-home service provider of the mobile terminal; when determining, based on the information of the called party, that the called party is a subscriber of the mobile terminal in the non-predetermined roaming country or non-predetermined roaming region, the ARP proxy engine selects a charging system provided by the home service provider of the mobile terminal.

As a preferred solution, the method of the present embodiment further performs the following call charging flow after step S106: the charging system selected by the ARP proxy engine transmits information related to the CAP protocol to the ARP proxy engine, e.g., RRB, AC, CUE; next, the ARP proxy engine transmits information related to the CAP protocol to the MSC, e.g., RRB, AC, CUE information; the MSC and the gateway used by the called party are connected based on ISUP, so as to connect the call to the called party; the MSC transmits a CAP response to the charging system through the ARP proxy engine; after the call is disconnected, the MSC transmits, via the ARP proxy engine, a message to the charging system so as to apply for a charging report; the charging system notifies the MSC to release the call through the ARP proxy engine.

According to the solution of the present embodiment, when the mobile terminal is in roaming in its predetermined roaming country or predetermined roaming region, and when the mobile terminal is a calling party, a charging system may be selected through the ARP proxy engine without number change, thereby increasing the flexibility of roaming service and reducing roaming charge in some cases.

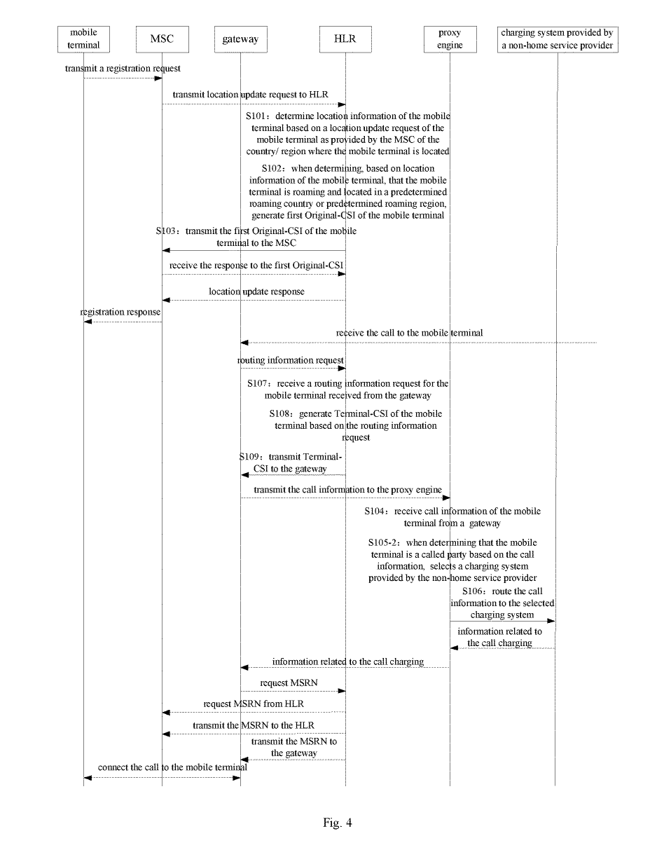

FIG. 4 shows a flow diagram of a method for serving a roaming mobile terminal in a mobile communication system according to a further embodiment of the present invention. The method according to the present embodiment comprises step S101, step S102, step S103, step S104, step S105, step S106, step S107, step S108 and step S109, wherein the step S105 further comprises step S105-2, and the step S101, the step S102, the step S103, the step S104, the step S106 have been described in detail with reference to FIG. 2, which will not be detailed here.

It should be noted that in the present embodiment, the mobile terminal is in roaming and is located in a predetermined roaming country or predetermined roaming region; moreover, the mobile terminal is a called party. Therefore, in step S104, the call information of the mobile terminal received by the ARP proxy engine comes from the gateway. The method according to the present embodiment further comprises the following steps before step S104: the gateway receives a call to the mobile terminal; and the gateway transmits a routing information request to the HLR to which the mobile terminal belongs based on the call.

Next, in step S107, the HLR receives a routing information request for the mobile terminal received from the gateway.

Herein, the routing information request is for requesting the Terminal-CSI of the mobile terminal, wherein the routing information request includes identification information of the mobile terminal, e.g., IMSI code of the mobile terminal.

In step S108, the HLR generates Terminal-CSI of the mobile terminal based on the routing information request.

Herein, the Terminal-CSI indicates the subscription information of the mobile terminal as a called party; a predetermined address entry in the Terminal-CSI is identical to a predetermined address entry in the first Original-CSI.

Specifically, the HLR queries current location information of the mobile terminal based on the identification information of the mobile terminal in the routing information request; when determining that the mobile terminal is located within a predetermined roaming country or predetermined roaming region, the HLR generates Terminal-CSI whose predetermined address entry includes the address information of the ARP proxy engine.

In step S109, the HLR transmits Terminal-CSI to the gateway.

Specifically, the HLR may transmit the Terminal-CSI of the mobile terminal to the gateway through a response to the routing information request.

In step S104 of the present embodiment, the ARP proxy engine receives call information of the mobile terminal from the gateway.

Next, in step S105-2, when determining that the mobile terminal is a called party based on the call information, the ARP proxy engine selects a charging system provided by the non-home service provider.

As a preferred solution, the method of the present embodiment further performs the following call charging flow after step S106: the charging system provided by the non-home service provider selected by the ARP proxy engine transmits information related to the call charge flow to the ARP proxy engine, e.g., RRB, AC, CUE, etc.; next, the ARP proxy engine forwards the information related to the call charging flow to the gateway; the gateway requests MSRN from HLR; the HLR requests MSRN from the MSC of the country or region where the mobile device is located; MSC transmits the MSRN to the HLR; the HLR transmits the MSRN to the gateway; the gateway connects a call to the mobile terminal.

According to the solution of the present embodiment, when the mobile terminal is roaming in its predetermined roaming country or predetermined roaming region and when the mobile terminal is a called party, a charging system provided by the non-home service provider of the terminal may be used to charge the roaming without number change, thereby reducing roaming charges.

It should be noted that, when the mobile terminal is in roaming and located in a non-predetermined roaming country or non-predetermined roaming region, and when the mobile terminal is a called party, the gateway directly transmits the call information to the charging system provided by the home service provider of the mobile terminal, so as to perform roaming charging.

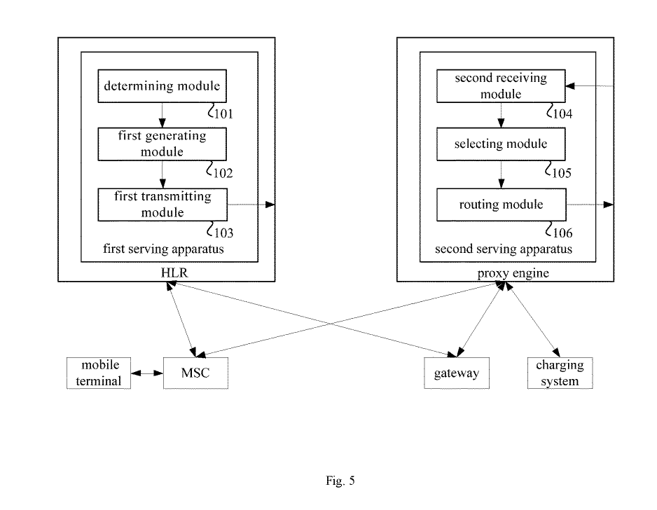

FIG. 5 shows a structural diagram of a system for serving a roaming mobile terminal in a mobile communication system according to one embodiment of the present invention. Herein, the charging system as shown in FIG. 5 comprises a charging system provided by a home service provider and a charging system provided by a non-home service provider. The mobile communication system according to the present embodiment comprises a HLR, an ARP proxy engine, an MSC, a gateway, and a charging system. Herein, the HLR comprises a first serving apparatus, the first serving apparatus comprising a determining module 101, a first generating module 102, and a first transmitting module 103, wherein the ARP proxy engine comprises a second serving apparatus, the second serving apparatus comprising a second receiving module 104, a selecting module 105, and a routing module 106.

Hereinafter, a registration process initiated by the terminal to the MSC including operations performed by the determining module 101, the first generating module 102, and the first transmitting module 103.

Before the operation of determining module 101, when a mobile terminal roams to a country or region, the mobile terminal sends a registration request to an MSC in the country or region where it is located, to request for registration with a VLR corresponding to the MSC.

After receiving the registration request from the mobile terminal, the MSC sends a location update request to the HLR of the mobile terminal.

The determining module 101 determines location information of the mobile terminal based on a location update request of the mobile terminal as provided by the MSC of the country or region where the mobile terminal is located.

Herein, the location update request is for requesting for updating a current location of the mobile terminal recorded in the HLR. Preferably, the location update request includes, but not limited to:

1) identification information of the mobile terminal, e.g., IMIS code of the mobile terminal;

2) MSC address information of the country/region where the mobile terminal is located, the address information is for indicating the address of the MSC;

3) the number information of the VLR of the country/region where the mobile terminal is located, the number information being for defining the ISDN number of the VLR.

Specifically, the determining module 101 determines current location information of the mobile terminal based on a location update request for the mobile terminal as provided by the MSC of the country/region where the mobile terminal is located.

For example, the determining module 101 determines the country or region where the MSC is located, based on the location update request for the mobile terminal as provided by the MSC of the country/region where the mobile terminal is located, thereby determining the current location information of the mobile terminal.

It should be noted that the above example is only for better illustrating the technical solution of the present invention, not limiting the present invention. Those skilled in the art should understand that any implementation manner of determining location information location information of the mobile terminal based on a location update request for the mobile terminal as provided by the MSC of the country/region where the mobile terminal is located should be included within the scope of the present invention.

When determining, based on location information of the mobile terminal, that the mobile terminal is roaming and located in a predetermined roaming country or predetermined roaming region, the first generating module 102 generates first Original-CSI of the mobile terminal.

Wherein, the first Original-CSI indicates subscription information when the mobile terminal located in the predetermined roaming country or predetermined roaming region is a calling party. Preferably, a predetermined address entry in the first Original-CSI includes address information of an ARP proxy engine. Wherein, the predetermined address entry in the first Original-CSI indicates an address entry of the location to which a call from the mobile terminal as a calling party is routed; preferably, the predetermined address entry is an SCF address.

For example, the first generating module 102 determines, based on the location information of the mobile terminal, that the country where the mobile terminal is currently located is not its home country and the country where the mobile terminal is currently located is its predetermined roaming country; then the first generating module 102 generates first Original-CSI of the mobile terminal and sets an SFC address in the first Original-CSI as the address of the ARP proxy engine.

It should be noted that the above example is only for better illustrating the technical solution of the present invention, not limiting the present invention. Those skilled in the art should understand any manner of generating first Original-CSI of the mobile terminal when determining that the mobile terminal is roaming and located in a predetermined roaming country or predetermined roaming region based on location information of the mobile terminal should be included within the scope of the present invention.

The first transmitting module 103 transmits the first Original-CSI of the mobile terminal to the MSC that transmits a location update request to the HLR.

For example, in the system as shown in FIG. 1, the MSC2 transmits a location update request to the HLR before the operation performed by the determining module 101 of HLR, and first transmitting module 103 transmits first Original-CSI to the MSC2.

Preferably, the first transmitting module 103 may transmits the first Original-CSI of the mobile terminal to the MSC through an Insert Subscribe Data message transmitted to the MSC, wherein the Insert Subscribe Data message may further include MSIDSN (mobile IDSN number) and Bearer Service information, etc.

Preferably, after the operation performed by the first transmitting module 103, the present embodiment further comprises the following operations performed between MSC, HLR and the mobile terminal: after receiving the first Original-CSI from the HLR, the MSC transmits a response to the first Original-CSI to the HLR; after receiving the response, the HLR transmits, to the MSC, a location update response to the location update request from the MSC; after receiving the location update response, the MSC transmits its response to the registration request to the mobile terminal, to complete registration of the mobile terminal in the MSC. These preferred steps are represented in dotted line.

After the registration is completed, the mobile terminal may make a call. Hereinafter, in the case that the HLR generates the first Original-CSI, a process of selecting a charging system for a call from the mobile terminal, including the operations performed by the second receiving module 104, the selecting module 105, and the routing module 106, will be illustrated.

The second receiving module 104 receives call information of the mobile terminal from an Gateway or MSC of the country where the mobile terminal is located.

Herein, the call information is for triggering a call service flow, wherein the call information may include any information related to the current call. Preferably, the call information includes: service key, status of the mobile terminal, a calling party number, a called party number, location information of the calling party, and location information of the called party, etc.

In the present embodiment, the gateway is a GMSC of the home country or region of the user.

The selecting module 105 selects, based on the call information, a charging system provided by either a home service provider or a non-home service provider of the mobile terminal.

Wherein, a specific implementation manner in which the selecting module 105 selects, based on the call information, a charging system provided by either a home service provider or a non-home service provider of the mobile terminal will be described in detail in subsequent embodiments, which will not be detailed here.

The routing module 106 routes the call information to the selected charging system.

Preferably, after the operation of the routing module 106, the mobile communication system of the present embodiment may also perform a related call charging flow. The call charging flow will be described in detail in the subsequent embodiments, which will not be detailed here.

According to the solution in the present embodiment, a subscriber may select a non-home service provider in its home country or region other than its home service provider to provide roaming services for the mobile terminal, so as to both enjoy roaming services provided by its home service provider and the non-home service provider without number change, such that when the mobile terminal is roaming in its predetermined roaming country or predetermined roaming region, selection may be performed between a charging system provided by its home service provider or a charging system provided by the non-home service provider; according to the solution of the present embodiment, the subscriber is provided a greater selectivity, such that the subscriber may select a roaming service provided by a non-home service provider with less roaming charge based on the country or region where he or she is roaming, thereby greatly reducing the expenses for roaming.

As a preferred solution, the first serving apparatus according to the present embodiment further comprises a third generating module (not shown) and a third transmitting module (not shown): when determining, based on location information of the mobile terminal, that the mobile terminal is in roaming and located in a non-predetermined roaming country or non-predetermined roaming region, the third generating module generates a second Original-CSI of the mobile terminal; and the third transmitting module transmits the second Original-CSI to the MSC providing a location update request.

Wherein the second Original-CSI indicates subscription information of the mobile terminal located in a non-predetermined roaming country or non-predetermined roaming region as a calling party. Herein, a predetermined address entry in the second Original-CSI includes address information of the charging system of the home service provider of the mobile terminal.

For example, the third generating module determines, based on the location information of the mobile terminal, that the country where the mobile terminal is located is not its home country, and the country where the mobile terminal is its non-predetermined roaming country, then the HLR generates second Original-CSI of the mobile terminal, and sets the predetermined address entry in the second Original-CSI as an address of the charging system of the home service provider of the mobile terminal; and the third transmitting module transmits the second Original-CSI to the MSC.

Therefore, when the mobile terminal roams to a non-predetermined roaming country or a non-predetermined roaming region, the home service provider of the mobile terminal may charge roaming of the mobile terminal.

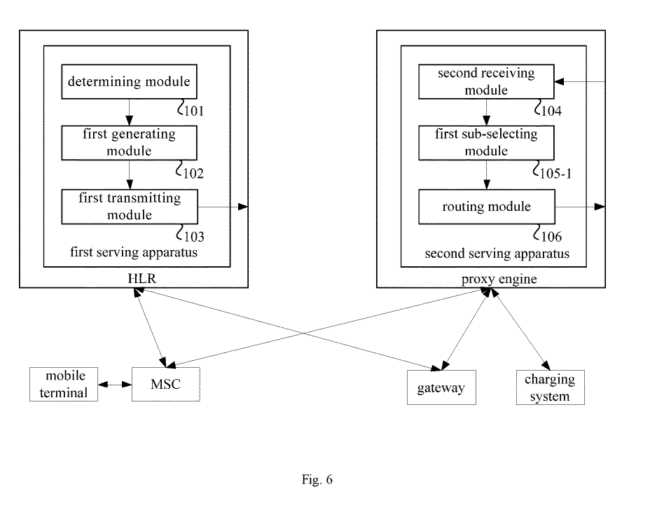

FIG. 6 shows a structural diagram of a system for serving a roaming mobile terminal in a mobile communication system according to another embodiment of the present invention. Herein, the charging system as shown in FIG. 6 comprises a charging system provided by a home service provider and a charging system provided by a non-home service provider. The mobile communication system according to the present embodiment comprises a HLR, an ARP proxy engine, an MSC, a gateway, and a charging system. Herein, the HLR comprises a first serving apparatus, the first serving apparatus comprising a determining module 101, a first generating module 102, and a first transmitting module 103, wherein the ARP proxy engine comprises a second serving apparatus, the second serving apparatus comprising a second receiving module 104, a selecting module 105, and a routing module 106; wherein the selecting module 105 further comprises a first sub-selecting module 105-1. Herein, the determining module 101, the first generating module 102, the first transmitting module 103, the second receiving module 104, and a routing module 106 have been described in detail with reference to FIG. 5, which will not be detailed here.

It should be noted that in the present embodiment, the mobile terminal is in roaming and located in a predetermined roaming country or predetermined roaming region, and the mobile terminal is a calling party. The present embodiment further comprises the following operations performed in the mobile communication system: before the operation of the second receiving module 104, the mobile terminal initiates a call to another mobile terminal through the MSC; and the MSC transmits the call information to the ARP proxy engine based on the first Original-CSI provided by the first transmitting module 103. Therefore, the second receiving module 104 of the present embodiment receives call information of the mobile terminal from the MSC of the country or region where the mobile terminal is located.

When determining, based on the call information, that the mobile terminal is a calling party, the first sub-selecting module 105-1 selects a charging system provided by either a home service provider or a non-home service provider of the mobile terminal, based on whether the called party is located in a predetermined roaming country or predetermined roaming region or not

Specifically, when determining that the mobile terminal is the calling party based on the call information, the first sub-selecting module 105-1 obtains information of the called party based on the call information. When determining, based on the information of the called party, that the called party is a subscriber of the mobile terminal in the predetermined roaming country or predetermined roaming region, the first sub-selecting module 105-1 selects a charging system provided by the non-home service provider of the mobile terminal; when determining, based on the information of the called party, that the called party is a subscriber of the mobile terminal in the non-predetermined roaming country or non-predetermined roaming region, the first sub-selecting module 105-1 selects a charging system provided by the home service provider of the mobile terminal.

As a preferred solution, the present embodiment further performs the following call charging flow after the operation of the routing module 106: the charging system selected by the ARP proxy engine transmits information related to the CAP protocol to the ARP proxy engine, e.g., RRB, AC, CUE; next, the ARP proxy engine transmits information related to the CAP protocol to the MSC, e.g., RRB, AC, CUE information; the MSC and the gateway used by the called party are connected based on ISUP, so as to connect the call to the called party; the MSC transmits a CAP response to the charging system through the ARP proxy engine; after the call is disconnected, the MSC transmits, via the ARP proxy engine, a message to the charging system so as to apply for a charging report; the charging system notifies the MSC to release the call through the ARP proxy engine.

According to the solution of the present embodiment, when the mobile terminal is in roaming in its predetermined roaming country or predetermined roaming region, and when the mobile terminal is a calling party, a charging system may be selected through the ARP proxy engine without number change, thereby increasing the flexibility of roaming service and reducing roaming charge in some cases.

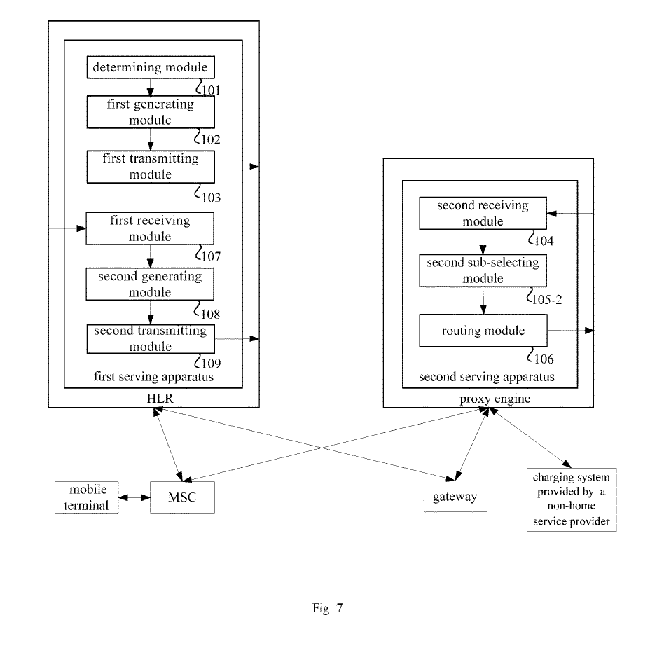

FIG. 7 shows a structural diagram of a system for serving a roaming mobile terminal in a mobile communication system according to a further embodiment of the present invention. Herein, the mobile communication system according to the present embodiment comprises a HLR, an ARP proxy engine, an MSC, a gateway, and a charging system provided by a non-home service provider. Herein, the HLR comprises a first serving apparatus, the first serving apparatus comprising a determining module 101, a first generating module 102, a first transmitting module 103, a first receiving module 107, a second generating module 108, and a second transmitting module 109, wherein the ARP proxy engine comprises a second serving apparatus, the second serving apparatus comprising a second receiving module 104, a selecting module 105, and a routing module 106; wherein the selecting module 105 further comprises a second sub-selecting module 105-2. Herein, the determining module 101, the first generating module 102, the first transmitting module 103, the second receiving module 104, and a routing module 106 have been described in detail with reference to FIG. 5, which will not be detailed here.

It should be noted that in the present embodiment, the mobile terminal is in roaming and is located in a predetermined roaming country or predetermined roaming region; moreover, the mobile terminal is a called party. Therefore, the call information of the mobile terminal received by the second receiving module 104 comes from the gateway. The present embodiment further comprises the following operations performed before the second receiving module 104 of the ARP proxy engine: the gateway receives a call to the mobile terminal; and the gateway transmits a routing information request to the HLR to which the mobile terminal belongs based on the call.

Next, the first receiving module 107 of the HLR receives a routing information request for the mobile terminal received from the gateway.

Herein, the routing information request is for requesting the Terminal-CSI of the mobile terminal, wherein the routing information request includes identification information of the mobile terminal, e.g., IMSI code of the mobile terminal.

The second generating module 108 generates Terminal-CSI of the mobile terminal based on the routing information request.

Herein, the Terminal-CSI indicates the subscription information of the mobile terminal as a called party; a predetermined address entry in the Terminal-CSI is identical to a predetermined address entry in the first Original-CSI.

Specifically, the second generating module 108 queries current location information of the mobile terminal based on the identification information of the mobile terminal in the routing information request; when determining that the mobile terminal is located within a predetermined roaming country or predetermined roaming region, the second generating module 108 generates Terminal-CSI whose predetermined address entry includes the address information of the ARP proxy engine.

The second transmitting module 109 transmits Terminal-CSI to the gateway.

Specifically, the second transmitting module 109 may transmit the Terminal-CSI of the mobile terminal to the gateway through a response to the routing information request.

The second transmitting module 109 of the present embodiment receives call information of the mobile terminal from the gateway.

Next, when determining that the mobile terminal is a called party based on the call information, the second sub-selecting module 105-2 selects a charging system provided by the non-home service provider.

As a preferred solution, the present embodiment further performs the following call charging flow after the operation performed by the routing module 106: the charging system provided by the non-home service provider selected by the ARP proxy engine transmits information related to the call charge flow to the ARP proxy engine, e.g., RRB, AC, CUE, etc.; next, the ARP proxy engine forwards the information related to the call charging flow to the gateway; the gateway requests MSRN from HLR; the HLR requests MSRN from the MSC of the country or region where the mobile device is located; MSC transmits the MSRN to the HLR; the HLR transmits the MSRN to the gateway; the gateway connects a call to the mobile terminal.

According to the solution of the present embodiment, when the mobile terminal is roaming in its predetermined roaming country or predetermined roaming region and when the mobile terminal is a called party, a charging system provided by the non-home service provider of the terminal may be used to charge the roaming without number change, thereby reducing roaming charges.

It should be noted that, when the mobile terminal is in roaming and located in a non-predetermined roaming country or non-predetermined roaming region, and when the mobile terminal is a called party, the gateway directly transmits the call information to the charging system provided by the home service provider of the mobile terminal, so as to perform roaming charging.

It should be noted that the present invention may be implemented in software and/or a combination of software and hardware. For example, each module of the present invention may be implemented by an application-specific integrated circuit (ASIC) or any other similar hardware device. In one embodiment, the software program of the present invention may be executed through a processor to implement the steps or functions as mentioned above. Likewise, the software program (including relevant data structure) of the present invention may be stored in a computer readable recording medium, e.g., RAM memory, magnetic or optic driver or soft floppy or similar devices. Additionally, some steps or functions of the present invention may be implemented by hardware, for example, a circuit cooperating with the processor so as to implement various steps of functions.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. A method for serving a roaming mobile terminal in an HLR of a mobile communication system, wherein the method comprising:
determining location information of the mobile terminal based on a location update request of the mobile terminal as provided by an MSC of a country or region where the mobile terminal is located;
when determining, based on location information of the mobile terminal, that the mobile terminal is in roaming and located in a predetermined roaming country or predetermined roaming region, generating first Original-CSI of the mobile terminal, wherein a predetermined address entry in the first Original-CSI includes address information of an ARP proxy engine;
transmitting the first Original-CSI to the MSC.

2. The method according to claim 1, wherein the mobile terminal is a called party and the mobile terminal is located in a predetermined roaming country or a predetermined roaming region, the method further comprises the following after the transmitting the first Oriqinal-CSI to the MSC:
receiving a routing information request for the mobile terminal from the gateway;
generating Terminal-CSI of the mobile terminal based on the routing information request, wherein a predetermined address entry in the Terminal-CSI is identical to the predetermined address entry in the first Original-CSI;
transmitting the Terminal-CSI to the gateway.

3. The method according to claim 1, wherein the method further comprising:
when determining, based on location information of the mobile terminal, that the mobile terminal is in roaming and located in a non-predetermined roaming country or non-predetermined roaming region, generating second Original-CSI of the mobile terminal, wherein a predetermined address entry in the second Original-CSI includes address information of a charging system of the home service provider of the mobile terminal;
transmitting the second Original-CSI to the MSC.

4. The method according to claim 1, wherein the predetermined roaming country includes an EU country.

5. A method for serving a roaming mobile terminal in an ARP proxy engine in a mobile communication system, wherein the method comprising:
receiving call information of the mobile terminal from a gateway or MSC of a country where the mobile terminal is located;
selecting a charging system provided by either a home service provider or a non-homer service provider of the mobile terminal based on the call information;
routing the call information to the selected charging system.

6. The method according to claim 5, wherein the selecting comprises:
when determining, based on the call information, that the mobile terminal is a calling party, selecting a charging system provided by either a home service provider or a non-home service provider of the mobile terminal, based on whether the called party is located in a predetermined roaming country or predetermined roaming region or not.

7. The method according to claim 5, wherein the selecting comprises:
when determining, based on the call information, that the mobile terminal is a called party, selecting a charging system provided by the non-home service provider.

8. A first serving apparatus for serving a roaming mobile terminal in an HLR of a mobile communication system, wherein the first serving apparatus comprising:
a determining module configured to determine location information of the mobile terminal based on a location update request of the mobile terminal as provided by an MSC of a country or region where the mobile terminal is located;
a first generating module configured to, when determining, based on location information of the mobile terminal, that the mobile terminal is in roaming and located in a predetermined roaming country or predetermined roaming region, generate first Original-CSI of the mobile terminal, wherein a predetermined address entry in the first Original-CSI includes address information of an ARP proxy engine;
a first transmitting module configured to transmit the first Original-CSI to the MSC.

9. The first serving apparatus according to claim 8, wherein the mobile terminal is a called party and the mobile terminal is located in a predetermined roaming country or a predetermined roaming region, the first serving apparatus further comprises the following modules that perform operations after the first transmitting module:
a first receiving module configured to receive a routing information request for the mobile terminal from the gateway;
a second generating module configured to generate Terminal-CSI of the mobile terminal based on the routing information request, wherein a predetermined address entry in the Terminal-CSI is identical to the predetermined address entry in the first Original-CSI;
a second transmitting module configured to transmit the Terminal-CSI to the gateway.

10. The first serving apparatus according to claim 8, wherein the first serving apparatus further comprising:
a third generating module configured to, when determining, based on location information of the mobile terminal, that the mobile terminal is in roaming and located in a non-predetermined roaming country or non-predetermined roaming region, generate second Original-CSI of the mobile terminal, wherein a predetermined address entry in the second Original-CSI includes address information of a charging system of the home service provider of the mobile terminal;
a third transmitting module configured to transmit the second Original-CSI to the MSC.

11. The first serving apparatus according to claim 8, wherein the predetermined roaming country includes an EU country.

12. A second serving apparatus for serving a roaming mobile terminal in an ARP proxy engine in a mobile communication system, wherein the second serving apparatus comprising:
a second receiving module configured to receive call information of the mobile terminal from a Gateway or MSC of a country where the mobile terminal is located;
a selecting module configured to select a charging system provided by either a home service provider or a non-homer service provider of the mobile terminal based on the call information;
a routing module configured to route the call information to the selected charging system.

13. The second serving apparatus according to claim 12, wherein the selecting module comprising:
a first sub-selecting module configured to, when determining, based on the call information, that the mobile terminal is a calling party, select a charging system provided by either a home service provider or a non-home service provider of the mobile terminal, based on whether the called party is located in a predetermined roaming country or predetermined roaming region or not.

14. The second serving apparatus according to claim 12, wherein the selecting module comprising:
a second sub-selecting module configured to, when determining, based on the call information, that the mobile terminal is a called party, select a charging system provided by a non-home service provider.

15. A mobile communication system, comprising a first serving apparatus according to claim 8 and a second serving apparatus comprising a second receiving module configured to receive call information of the mobile terminal from a Gateway or MSC of a country where the mobile terminal is located, a selecting module configured to select a charging system provided by either a home service provider or a non-homer service provider of the mobile terminal based on the call information and a routing module configured to route the call information to the selected charging system.
